(19) United States
(12) Patent Application Publication
(10) Pub. No.: US 2005/0211379 A1
(43) Pub. Date: Sep. 29, 2005

(54) Apparatus and method for removing metal from wafer edge

(76) Inventors: Hung-Wen Su, Tainan (TW); Ming-Hsing Tsai, Hsinchu (TW)

Correspondence Address: BIRCH STEWART KOLASCH & BIRCH, PO BOX 747, FALLS CHURCH, VA, 22040-0747, US

(21) Appl. No.: 10/810,619

(22) Filed: Mar. 29, 2004

(51) Int. Cl. B44C 1/22

(52) U.S. Cl. 156/345.23; 216/83

(57) ABSTRACT

Apparatus and method for removing copper from wafer edge. The apparatus of the invention includes a bath tank for containing a chemical bath, a rotatable wafer chuck for holding a wafer vertical to the chemical bath, wherein at least the edge of the wafer is covered with a metal layer, and a sliding element is disposed on one end of the rotatable wafer chuck such that the rotatable wafer chuck can move in a vertical direction to the chemical bath.

### BACKGROUND

The present invention relates to an apparatus for removing unwanted metal from semiconductor wafers and in particular to an apparatus for removing unwanted metal in the wafer edge as well as a method for performing the same.

Damascene processing is a method for forming metal lines on integrated circuits. It is often a preferred method because it requires fewer processing steps than other methods and offers a higher yield. In damascene processing, as well as other integrated circuit manufacturing processes, the conductive routes on the surface of the circuit are generally formed out of a common metal, traditionally aluminum. Copper is a favored metal because of its higher conductivity and electromigration resistance when compared to aluminum. During integrated circuit fabrication, a conductive metal is needed on the active circuit of the wafer, i.e., the main interior region on the front side, but is undesirable elsewhere.

In a typical copper damascene process, the formation of the desired conductive routes generally begins with a thin physical vapor deposition (PVD) of a seed layer of the metal, followed by a thicker electrofill layer (which is formed by electroplating) thereof. The PVD method is typically sputtering. In order to maximize the size of the useable wafer area, the electrofilled metal must be deposited very near the edge of the semiconductor wafer. Thus, it is necessary to allow PVD of the seed layer of the metal over the entire front side of the wafer. As a byproduct of the process step, the seed layer of the PVD metal typically coats the front edge area outside the active circuit region, as well as the side edge and to some degree, the backside.

The metal remaining on the wafer edge after electrofill is undesirable for various reasons. One reason is that metal left at the edge after CMP is not suitable for subsequent layer deposition thereon. Another reason is the metal left at the edge tends to flake off during subsequent handling, thus generating undesirable particles. Moreover, the metal remaining on the wafer edge triggers false alarms during wafer input or output in subsequent processes, potentially causing downtime in the subsequent process tool.

Hence, there is a need for a method of removing the metal left at the wafer edge.

In U.S. Pat. No. 6,586,342, Mayer et al. disclose a method for removing copper from the edge bevel of a silicon wafer and the associated module for performing the same. Metal such as copper left at the wafer edge is removed by horizontally flowing liquid etchant on the front edge of the wafer, over the side edge, and onto the back edge.

### SUMMARY

Accordingly, an object of the invention is to provide an apparatus for removing unwanted metal from the wafer edge.

The apparatus for removing metal from the wafer edge includes a bath tank for containing a chemical bath, a rotatable wafer chuck for holding a wafer vertical to the chemical bath, wherein at least the edge of the wafer is covered with a metal layer, and a sliding element disposed on one end of the rotatable wafer chuck such that the rotatable wafer chuck can move in a vertical direction to the chemical bath.

Another object of the invention is to provide a method for removing unwanted metal from the wafer edge utilizing the apparatus of the invention.

The method for removing metal from the wafer edge of the invention includes the steps of providing a wafer with a metal layer at least covering the edge thereof. Next, a predetermined portion of the wafer is vertically immersed into a chemical bath for etching the metal layer. The wafer is then rotated to remove the metal layer of the predetermined portion from the surface and the edge thereof.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram showing an apparatus of the invention for removing metal from a wafer edge;

FIG. 2 is an enlargement of area 114 in FIG. 1 showing a metal layer formed near the wafer edge;

FIG. 3 is schematic diagram showing removal of metal from the wafer edge metal using the apparatus of the invention;

FIG. 4 is an enlargement of the area 114′ in FIG. 3 showing a result after the wafer edge metal removal; and

FIG. 5 is a flowchart showing a method of the invention for removing metal from a wafer edge.

### DESCRIPTION

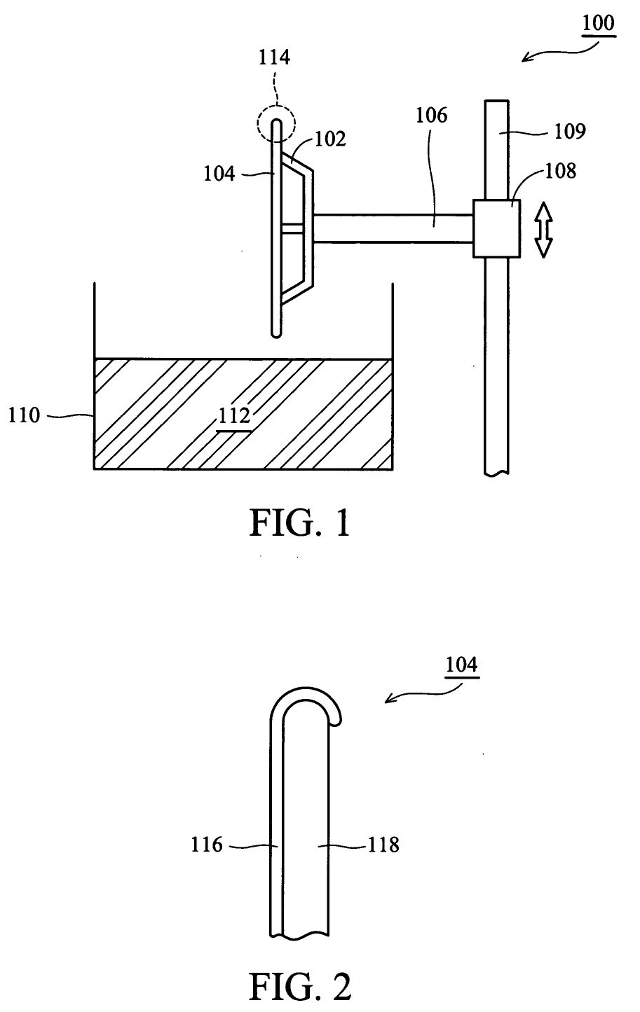

FIGS. 1 to 4 are schematic diagrams showing an apparatus of the invention for removing metal from a wafer edge and removal of the metal from the wafer edge. In FIG. 1, an apparatus 100 for metal removal is illustrated. The apparatus 100 includes a bath tank 110 for containing a chemical bath 112 for etching a predetermined metal. A wafer chuck 102 for holding a semiconductor wafer 104 vertical to the chemical bath 110 is provided and connected to a rotary device 106, thus forming a rotatable wafer chuck. The rotatable wafer chuck is further connected to a sliding element 108, capable for vertically moving and rotating the semiconductor wafer 104 clockwise or counterclockwise. The sliding element 108, such as a sleeve, is disposed around a vertical rod 109 for vertical s movement thereon. The chemical bath 112 can be an etching solution including ammonia, sulfuric, nitric, or hydrochloric acid, or combinations thereof, depending on the metal to be removed. When removing copper, a chemical bath containing sulfuric acid, H₂O₂ and DI water is preferably with a predetermined etching rate normally between 20 to 500 Å/sec to copper.

FIG. 2 shows an enlargement of area 114 in FIG. 1. The semiconductor wafer 104 includes a metal layer 116 formed on a semiconductor structure 118. The metal layer 116 can be, for example, a copper layer with a seed layer (not shown) formed by a conventional PVD method and a main layer (not shown) followed by copper electroplating. FIG. 2 shows that the metal layer 116 such as a copper layer, which is unfavorable to subsequent deposition and causes particle contamination, is formed on the edge and a portion of the backside of the semiconductor structure 118.

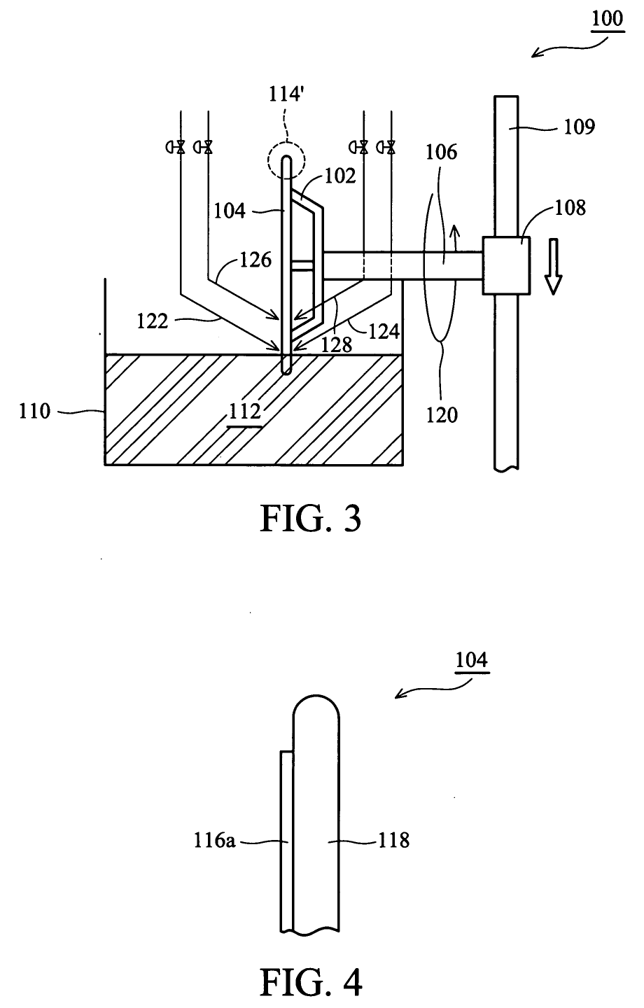

In FIG. 3, a predetermined portion of the semiconductor wafer 104 is then immersed in the chemical bath 112 through a downward movement of the sliding element 108 to remove metal from the wafer edge. For a 12-inch or 8-inch wafer, the predetermined portion is preferably about 1 to 5 mm, and more preferably about 1 to 2 mm, from the wafer edge. After the semiconductor wafer 104 is partially immersed in the chemical bath 112, the semiconductor wafer 104 is rotated by the rotating device 106 in a first direction 120 to uniformly remove metal from the edge of the wafer 104. The rotation speed can be preferably controlled at under 5 to 300 rpm, and more preferably under 10 to 150 rpm, to achieve better etching efficiency while maintaining uniformity.

Referring to the apparatus 100 in FIG. 3, first delivery lines 122 and 124 with outlet nozzles thereon can be provided during metal removal and function as suppression lines for respectively providing a suppressive flow, under the control of a valve, onto the front surface and rear surface of the semiconductor wafer 104 near the surface of the chemical bath 112. The suppressive flow can be a flow of inert gas such as N₂ or helium (He), for example, and the flow rate thereof is preferably between 5 to 100 sccm. Thus, splash from the chemical bath 112 due to wafer rotation can be suppressed and the metal layer (not shown) in the region other than the wafer edge can be protected from any undesirable etching.

Additionally, second delivery lines 126 and 128 with outlet nozzles thereon can be respectively provided on both surfaces of the wafer 104. The second delivery lines 126 and 128 are disposed in a position closer to the wafer center than the first delivery lines 122 and 124 to serve as rinse lines for providing a rinse flow on the semiconductor wafer 104 after the wafer edge metal removal. The rinse flow can be a liquid flow comprising deionized (DI) water with a flow rate of between 500 to 30000 ml/min. Thus, etching solution residue of the chemical bath 112 on the semiconductor wafer 104 can be removed leaving a partially etched metal layer 116a over the semiconductor structure 118, as illustrated by the enlargement of region 114′ in FIG. 4. No metal residue is found on the wafer edge, a predetermined portion near the wafer edge, or the backside of the wafer.

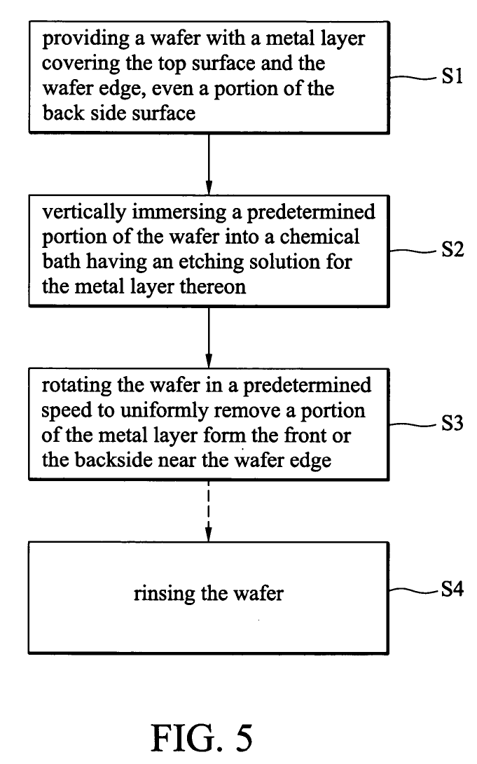

In the present invention, a method for removing unwanted metal from the wafer edge is illustrated by the process flow illustrated in FIG. 5. The method for removing unwanted metal can be performed by the apparatus 100 illustrated in FIG. 1 or FIG. 3.

In step S1, a wafer with a metal layer covering the top surface, an edge thereof, and a portion of the back side is provided. Next, a predetermined portion of the wafer is vertically immersed into a chemical bath containing an etching solution for etching the metal layer thereon, as shown in step S2. In step S3, the wafer is then rotated at a predetermined speed to uniformly remove a portion of the metal layer from the front or the back side near the wafer edge. During the metal removal, a suppressive flow can be provided to the surface of the chemical bath on either or both sides of the wafer to prevent undesirable splashing of etching solution. Optionally, the wafer can be then rinsed by a rinse flow containing rinse′ fluid such as DI water to remove etching solution residue therefrom, as shown in step S4.

The present invention provides a novel apparatus for removing unwanted metal from the wafer edge. A predetermined portion of a metal layer formed on a wafer is vertically immersed into a chemical bath having a proper etching solution for the metal and then rotated in the chemical bath to uniformly remove the metal from the wafer edge. The present invention provides both an apparatus and a method distinct to that disclosed in U.S. Pat. No. 6,586,342, in that, the wafer is vertically rotated during the wafer edge metal removal and the portion of the metal layer immersed in the chemical bath can be properly adjusted according to a possible active area region defined on a wafer by a sliding element of the apparatus of the invention.

Subsequent to the wafer edge metal removal, wafer ejections during wafer sorting in the subsequent process tool can be reduced and up-time thereof is thus increased. Moreover, a possible particle source is eliminated and contamination therefrom can be prevented.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An apparatus for removing metal from a wafer edge, comprising:
a bath tank for containing a chemical bath;
a rotatable wafer chuck for holding a wafer vertical to the chemical bath, wherein at least the edge of the wafer is covered with a metal layer; and
a sliding element disposed on one end of the rotatable wafer chuck such that the rotatable wafer chuck can move in a vertical direction to the chemical bath.

2. The apparatus as claimed in claim 1, further comprising a front suppression line disposed substantially in front of the wafer and near the surface of the chemical bath to provide a first flow for suppressing the chemical bath from splashing the wafer.

3. The apparatus as claimed in claim 2, wherein the first flow comprises an inert gas with a flow rate between 5˜100 sccm.

4. The apparatus as claimed in claim 1, further comprising a front rinse line disposed in front of the wafer to provide a rinse fluid for cleaning the front wafer surface.

5. The apparatus as claimed in claim 4, wherein the flow rate of the rinse fluid is between 500˜30000 ml/min.

6. The apparatus as claimed in claim 2, further comprising a front rinse line disposed in front of the wafer and in a position closer to the wafer center than the front suppression line to provide rinse fluid for S cleaning the front wafer surface.

7. The apparatus as claimed in claim 6, wherein the flow rate of the rinse fluid is between 500˜30000 ml/min.

8. The apparatus as claimed in claim 1, further comprising a rear suppression line disposed substantially behind the wafer and near the surface of the chemical bath to provide a second flow for suppressing the chemical bath from splashing the wafer.

9. The apparatus as claimed in claim 8, wherein the second flow comprises an inert gas with a flow rate between 5˜100 sccm.

10. The apparatus as claimed in claim 1, further comprising a rear rinse line disposed behind the wafer to provide a rinse fluid for cleaning the rear wafer surface.

11. The apparatus as claimed in claim 10, wherein the flow rate of the rinse fluid is between 500˜30000 ml/min.

12. The apparatus as claimed in claim 8, further comprising a rear rinse line disposed behind the wafer and in a position closer to the wafer center than the rear suppresive nozzle to provide rinse fluid for cleaning the rear wafer surface.

13. The apparatus as claimed in claim 12, wherein the flow rate of the rinse fluid is between 500˜30000 ml/min.

14. A method for removing metal from a wafer edge, comprising the steps of:
providing a wafer with a metal layer at least covering the edge thereof;
vertically immersing a predetermined portion of the wafer into a chemical bath for etching the metal layer; and
rotating the wafer to remove the metal layer of the predetermined portion from the surface and the edge thereof.

15. The method as claimed in claim 14, wherein the predetermined portion is about 1˜5 mm from the wafer edge.

16. The method as claimed in claim 14, further comprising the step of providing a front suppression flow to the surface of the chemical bath near the front wafer surface during the wafer edge metal removal to suppress the chemical bath from splashing a portion of the wafer.

17. The method as claimed in claim 16, wherein the front suppression flow is provided by a front suppression line disposed in front of the front wafer surface.

18. The method as claimed in claim 16, wherein the front suppression flow comprises an inert gas.

19. The method as claimed in claim 14, further comprising the step of providing a front rinse flow for cleaning the front wafer surface subsequent to the wafer edge metal removal.

20. The method as claimed in claim 19, wherein the front rinse flow is provided by a front rinse line disposed in front of the wafer.

21. The method as claimed in claim 16, further comprising the step of providing a rinse fluid to the front wafer surface for cleaning the rear wafer surface subsequent to the wafer edge metal removal.

22. The method as claimed in claim 16, wherein the front rinse flow is provided by a front rinse line disposed in front of the wafer and in a position closer to the wafer center than the front suppression line.

23. The method as claimed in claim 14, wherein the wafer is rotated at a speed between 5 to 300 rpm by a rotatable wafer chuck.

24. The method as claimed in claim 14, wherein the metal layer is a copper layer.

25. The method as claimed in claim 24, wherein the chemical bath comprises a solution of sulfuric acid, H₂O₂ and DI water.

26. The method as claimed in claim 14, which is performed using the apparatus of claim 1, comprising the steps of:
disposing the wafer on the rotatable wafer chuck;
vertically immersing the wafer edge into the chemical bath by moving the sliding element; and
rotating the rotatable wafer chuck to remove the metal layer at the wafer edge.
